(19) United States
(12) Patent Application Publication
(10) Pub. No.: US 2012/0126699 A1
(43) Pub. Date: May 24, 2012

(54) LED Light Bulb with Battery Backup and Remote Operation

(76) Inventor: Michael Zittel, Rockford, IL (US)

(21) Appl. No.: 13/114,984

(22) Filed: May 24, 2011

Related U.S. Application Data
(60) Provisional application No. 61/414,986, filed on Nov. 18, 2010.

(51) Int. Cl. H05B 37/00; F21V 19/04

(52) U.S. Cl. 315/86; 362/20

(57) ABSTRACT

An LED lighting device is presented for both general illumination and emergency backup lighting. The device has an outer bulb shell with air vents to release heat. A metal threaded base is adapted to fit into a standard incandescent bulb socket and to allow electrical current to flow into the device. Housed within the outer bulb shell, and removably connecting the shell to the metal base is a lighting assembly. The lighting assembly is a cylindrical structure comprising bright LEDs arranged along its outer surface, some of which are powered via wall outlet power from the metal base of the device, while others utilize an internal battery power source housed within the assembly. The battery powered LEDs may be remotely activated by a remote control means. Use of the remote control sends a signal to a signal receiving means on or within the device that directs the backup LEDs to illuminate.

### CROSS REFERENCE TO RELATED APPLICATION

This application claims the benefit of U.S. Provisional Application No. 61/484,916 filed on Nov. 18, 2010, entitled “Give Me Light.”

### BACKGROUND OF THE INVENTION

1. Field of the Invention

The present invention relates to a device for providing general lighting via light emitting diodes (LEDs) and more specifically to a device for providing emergency backup lighting.

LEDs were originally used as indicators because of their limited color spectrum and intensity. They could be found on aviation control panels and computer mainframes. Modern uses of LED lighting are far more diverse. Developments in lighting technology and semi-conductor construction have lead to higher intensity (“bright”) LEDs that are available in every color in the visible light spectrum as well as infrared and ultra-violet. In practice, LEDs are commonly used for emergency and safety lighting purposes. LED's low energy consumption, long lamp life, and diminutive size make them an attractive option as an emergency lighting source. Step lighting, emergency signs, and pathway lighting are examples of emergency lighting uses where LEDs are now standard.

These forms of emergency backup lighting are efficient and useful to commercial buildings and aircraft, which have backup generators and powerful alternative power sources. Such uses present logistical problems for homeowners with limited energy reserve resources and with respect to wiring of home pathways, entrances and steps with emergency lighting. Flashlights that utilize LEDs can help to solve the problem of readily available emergency lighting, however these items are often misplaced by users, and without regular use their battery resources go unchecked over long periods of nonuse.

Without a reliable source of emergency lighting during a power outage, individuals are at risk of injury. An individual fumbling in the dark for a flashlight could cut themselves on an unseen sharp object, trip over an item on the floor, or otherwise injure themselves. To reduce the risk of injuries, a light source is needed that integrates with already available lighting. The small size of LEDs makes them easy to integrate into existing lighting fixtures in the home, and their low energy consumption allows them to be powered by commonly available batteries. Integrated LED backup lighting that automatically activates during power outages would decrease the risk of low visibility related injuries. If such LED lighting were activated remotely by a user wishing to provide light to a third party, then risk of injury to elderly, infirm, and children caused by low visibility may be reduced.

2. Description of the Prior Art

The prior art discloses a variety of light emitting diode (LED) lighting devices for both general illumination and backup lighting purposes. These devices have familiar design and structural elements for the purposes of providing general illumination and/or backup lighting, however they are not disclose a modular light bulb shell having air vents for cooling, a cylindrical lighting assembly having LEDs positioned about its surface, or a removable battery housing for providing a backup battery source.

Hutchins, U.S. Patent Application Publication No. 2005/0162127 discloses an LED light powered by a lithium battery and selectively connected to the same by a switch. Said battery, LED light, switch, and all associated circuitry are housed within the same casing.

Petrakis, et al., U.S. Patent Application Publication No. 2007/2036946 discloses a lighting assembly comprising a bundle of wire operatively connected to a series of solid state light emitting sources. Said lighting sources being electrically connected to said trim by means of the wire bundle. An electrical junction capable of receiving electric current that operatively connects to an incandescent socket and the light emitting source. One embodiment of the device includes a battery source and controller means to provide enough electrical current to illuminate the first solid state lighting device in the event primary power is unavailable.

Wrobel, U.S. Pat. No. 5,303,124 discloses a sign module comprising an array of LEDs secured to a baseboard and operatively connected to a standard incandescent socket means and a battery backup. The battery source is automatically engaged when a default power source is turned off, allowing the LEDs to illuminate.

Bavaro et al., U.S. Pat. No. 5,734,229 discloses a backup light source assembly for a lamp comprising an AC power source and a low voltage replaceable battery attached to an AC to DC converter inside the lamp. Said battery source is adapted to power a compact fluorescent bulb for a short time after a power outage.

Bavaro et al, U.S. Pat. No. 6,107,744 discloses a backup lighting system comprising a fluorescent bulb, a primary energy source, a sensing means for detecting interruption to power, and a rechargeable secondary energy source for powering the light bulb in the event that the primary energy source fails.

Izardel, U.S. Pat. No. 7,347,586 an LED lighting device comprising an LED light bulb having a plurality of LEDs mounted along the rim of said light bulb's base. This assembly is surrounded by a reflective shell adapted to redirect light from the LEDs upward thus enhancing the effectiveness of the lighting device.

Smith et al., U.S. Pat. No. 7,597,455 discloses an LED light bulb comprising a plurality of LED lightboards containing groups of similarly colored LEDs, a bulb housing, a heat sink, and a socket means for operatively connecting with an incandescent socket. In one embodiment the device contains a solar cell on the surface of said bulb shell that stores power in a battery contained within the device's base.

The aforementioned prior art patents fail to disclose a similarly structured device when compared to the present invention. They provide various means for powering LED light bulbs, backup power sources and various structures therefore. However, they do not disclose a modular bulb having a removable upper portion, a lower shell with air vents for thermal cooling, means for operatively connecting to an incandescent bulb socket, or a cylindrical lighting assembly having LEDs positioned along its outer surface.

The devices disclosed by the prior art do not address the need for remote operation of backup lighting by users who may not be able to easily reach the light bulb during power outages. The current invention relates to a device for LED lighting that allows a user to activate the battery operated lighting elements via a remote control. It substantially diverges in structural elements from the prior art, consequently it is clear that there is a need in the art for an improvement to the existing LED lighting devices. In this regard the instant invention substantially fulfills these needs.

### SUMMARY OF THE INVENTION

In view of the foregoing disadvantages inherent in the known types of LED lighting devices now present in the prior art, the present invention provides a new modular bulb shell and cylindrical lighting assembly removably housing a replaceable battery source, wherein the same can be utilized for providing convenience for the user during power outages when primary lighting sources are unavailable. The lighting device of the present invention comprises a series of light emitting diode (LED) bulbs, an outer bulb shell, an activation sensor, a metal threaded base, a battery source, and a remote control means. Said outer bulb shell comprises a top portion and a bottom portion. The top portion of the bulb shell is threaded along its outer rim so that it may be removably secured to said bottom portion. Air vents are disposed along the surface of the lower portion to allow heat dissipation.

Within the outer bulb shell is housed an inner lighting assembly. A variable number of bright LED lights are positioned along the outer surface of the inner light assembly, which is cylindrical in shape. High intensity, bright LEDs are used for greater light output and a greater variety of available colors. The LEDS powered by two distinct power sources. Some of the LED lights receive electrical power via a standard electrical light socket, while others are powered by the internal battery source. The device contains control circuitry to activate the LEDs according to their wired power source. In an alternate embodiment, both groupings of LED lights are active at all times, though the lights powered by standard electrical current would be unavailable during power outages. In another exemplary embodiment, the wall outlet power provides a means to charge a rechargeable internal battery to ensure adequate power in an outage situation.

Power is provided to the device by standard AC power that is converted into DC, along with an onboard battery power source. Standard AC electricity is carried into the device through a metal threaded base adapted to fit within a standard light socket. The AC is converted to DC via a rectifier control circuit. The base portion is removably connected to the outer bulb that houses the inner lighting assembly. The battery source is removably housed within the inner lighting assembly. Any battery type such as alkaline, lithium, lithium ion, or nickel cadmium may be used as a battery source. A user may replace the battery by unscrewing the metal threaded base and removing the inner lighting assembly from the outer bulb shell, then exchanging the battery source. Additionally, a user may replace the battery source by removing the top portion of the outer bulb shell and unscrewing the lighting assembly from the base, then lifting it out through the bottom portion of the shell.

A user may remotely activate the battery powered LED lights by depressing an “on/off” button on a remote control means. Depression of the button causes the remote control to emit a signal which can be received by the device sensor receiving means. In one embodiment, the signal means used by the remote control is a radio frequency transmission. Radio frequency remote controllers do not require line of sight between the controller and the sensing means, and are operable in a region large enough to cover most homes. During a power outage, the user may activate the battery powered LEDs in the device by using the remote control anywhere within the radio frequency range of coverage. In an alternate embodiment, the remote control may utilize infrared or near infrared signals. This embodiment requires line of sight between the controller and sensor. Consequently the remote control must remain in the same room as the lighting device. This presents an attractive option to hospital patients, members of nursing homes, or medical facilities, where a desiring light may be activated by directing the remote control at the desired bulb. The sensor means may be operatively attached to either the inner lighting assembly, or on the bulb shell of the device depending on the embodiment.

It is therefore an object of the present invention to provide a new and improved LED lighting device that has all of the advantages of the prior art and none of the disadvantages.

Another object of the present invention is to provide a new and improved LED lighting device containing a plurality of bright LED lights. A first set of the LED lights are powered by AC power and a second set are powered by an onboard, replaceable battery source.

Yet another object of the present invention is to provide a new and improved LED lighting device that allows a user to remotely activate a set of battery powered LED lights. The duration of the battery powered LEDs may be governed by a timing circuit to continually power their operation for a period of time.

Still another object of the present invention is to provide a new and improved LED lighting device having a sensor means for receiving signals from a remote control. The signal causes the device's control circuitry to turn a set of backup LED lights on or off.

Another object of the present invention is to provide a new and improved LED lighting device having a means for exchanging the battery source to prevent failure of the device during power outages due to low battery life.

Other objects, features and advantages of the present invention will become apparent from the following detailed description taken in conjunction with the accompanying drawings.

### BRIEF DESCRIPTIONS OF THE DRAWINGS

The above invention will be better understood and the objects set forth above as well as other objects not stated above will become more apparent after a study of the following detailed description thereof. Such description makes use of the annexed drawings, wherein:

FIG. 1 shows a perspective view of am LED light bulb according to a preferred embodiment of the present invention.

FIG. 2 shows a perspective view of an LED light bulb according to a preferred embodiment of the present invention, with the outer bulb shell separated into the top and bottom portions.

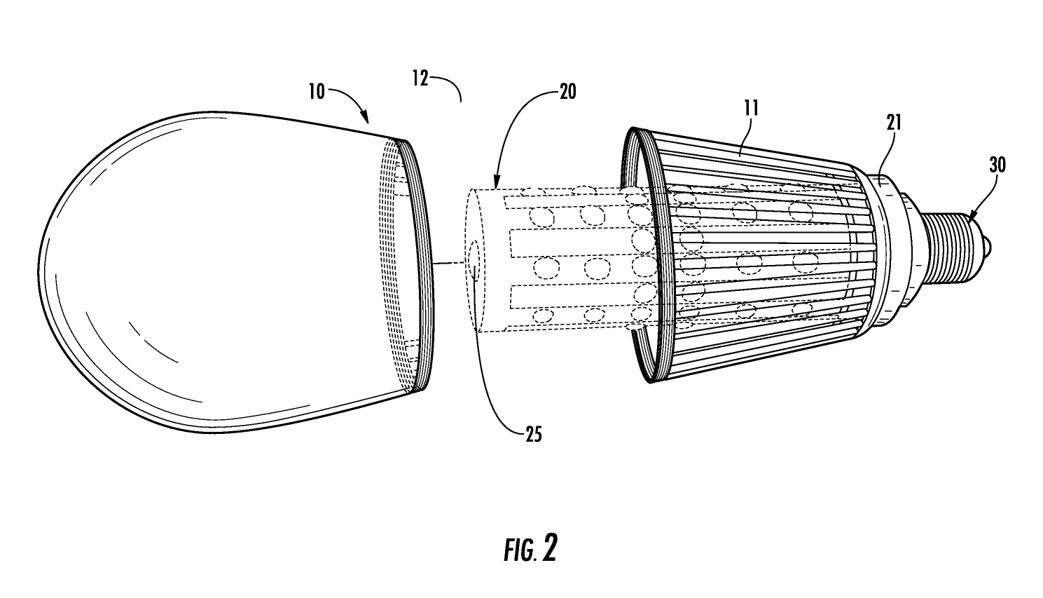

FIG. 3 shows a perspective view of the present invention's inner assembly. The end portion is shown unattached so that a battery may be inserted into the lighting assembly.

FIG. 4 shows a cross section view of an LED light bulb according to a preferred embodiment of the present invention.

### DETAILED DESCRIPTION OF THE INVENTION

Reference is made herein to the attached drawings. Like reference numerals are used throughout the drawings to depict like or similar elements of the claimed LED lighting device. For the purposes of presenting a brief and clear description of the present invention, the preferred embodiment will be discussed as used for remote activation of battery powered LED lighting. This is for representative purposes only and should not be considered to be limiting in any respect.

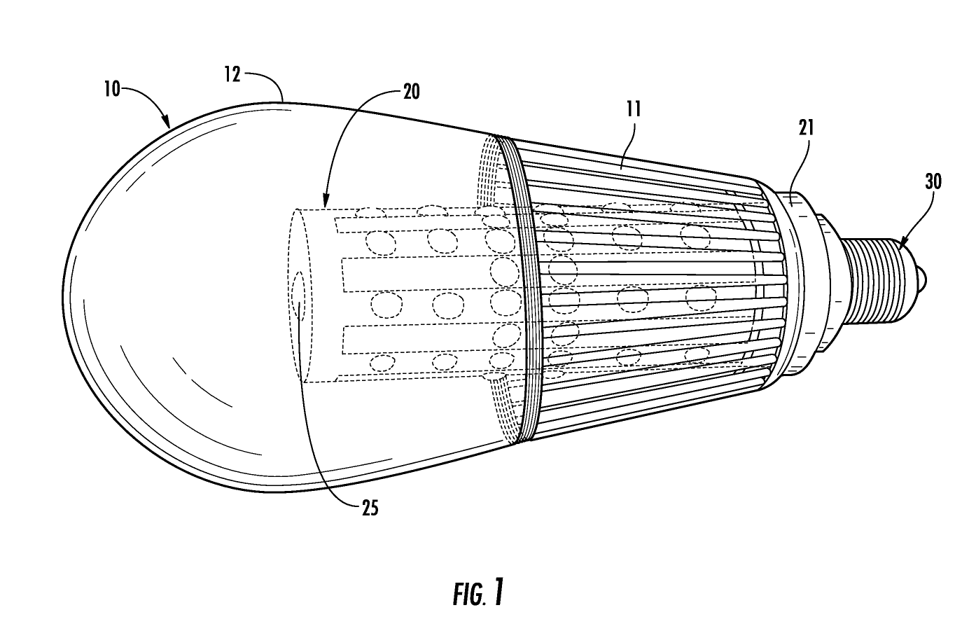

Referring now to FIGS. 1 & 2, there is shown an LED light bulb according to the present invention. The light bulb has an outer bulb shell 10, an inner lighting assembly 20, and a metal threaded base portion 30. Said outer bulb shell 10 encloses the inner lighting assembly 20 and acts as a housing for the same. The outer bulb shell has a bottom portion 11 and a top portion 12 that are removably secured together by a threaded screw means disposed at the rim of each portion. Air vents are positioned along the surface of the bottom portion 11 to allow heat generated from the LEDs and the conversion of electrical power to escape the interior region of the LED lighting device, thereby reducing the risk of damage caused by overheating. A variety of air vent arrangements are contemplated and may be customized to accommodate the shape of the bulb shell 10. The top portion of the bulb shell 12 may be semi-circular, cylindrical (not shown), spherical (not shown), or any other operable shape. This bulb shell 10 is removably connected to the lighting cylinder base 21 that has an opening at its center adapted to allow the metal threaded base 30 to be inserted and operatively connected. The bulb shell 10 may be constructed of any translucent, heat resistant material such as plastic or glass.

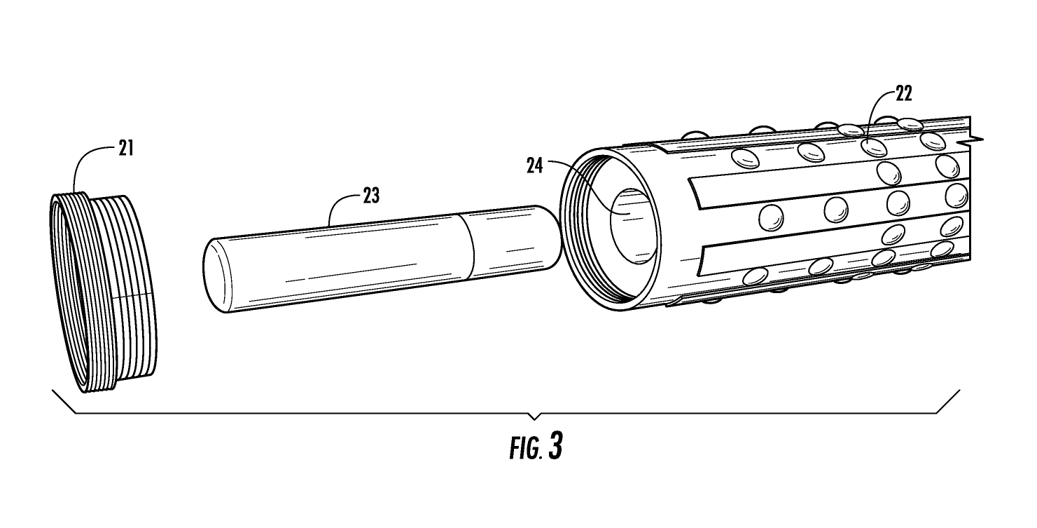

Referring now to FIG. 3, there is shown the inner lighting assembly 20 of the present LED lighting device. The assembly 20 is cylindrical in shape with a plurality of high intensity (“bright”) LEDs 22 positioned along its outer surface. The assembly 20 has a threaded base that can be removed by a user to insert a battery source 23 into a recess 24 in the cylindrical lighting assembly. The base portion 21 of the assembly is removably secured to the outer bulb shell 10 to allow a user to replace the battery source 23. Alternatively, the top portion 12 of the bulb shell 10 may be unscrewed and the inner lighting assembly 20 removed from within the bottom portion 11 of the bulb shell 10 to allow a battery source to be replaced. Any type of battery may be used, including alkaline, lithium, lithium ion, or nickel cadmium. In an alternate embodiment, the battery source may be rechargeable and the incoming AC power may continually recharge the battery prior to operation without wall outlet power in an emergency situation.

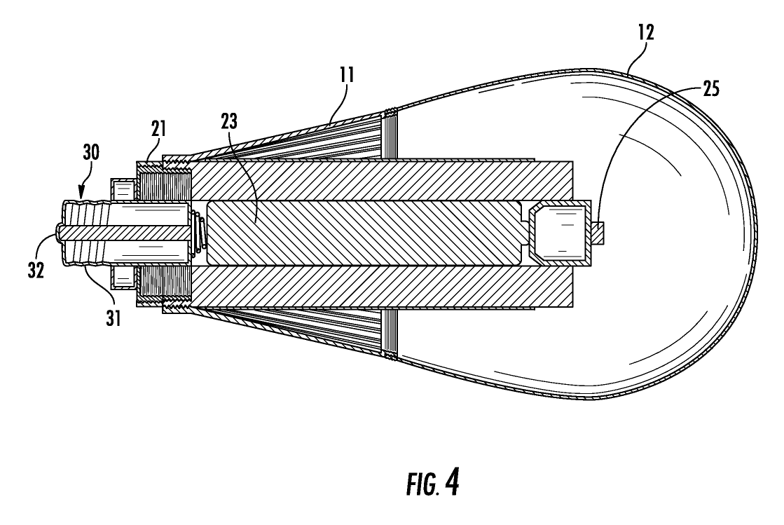

Referring now to FIG. 4 shown is a cross-sectional view of an LED light bulb according to the present invention. The inner lighting assembly 20 is housed within the outer bulb shell 10 and is secured to the metal threaded base portion 30. There are two groupings of LEDs; the first is powered by electrical current received through the device's metal threaded base 30, while the second grouping is powered by the internal battery source 23. The LEDs 22 may be arranged in any operable positioning, but should be electrically connected so as to illuminate simultaneously according to their grouping. The number and color of the LEDs may vary according to the intended purpose of the light bulb device. Illumination of the LED groupings is managed by control circuitry (not shown) that receives power from either the threaded base 30 or the battery source 23 if the former is unavailable. In an alternate embodiment, all LED lights are simultaneously illuminated, and the internal battery is charged view the power received through the threaded base 30 portion.

The metal threaded base portion 30 is adapted to fit a standard incandescent light bulb socket such as E12, E17, E26, E39 (North American) and their international equivalents. Metal screw threads 31 on the sides of the base secure the lighting device into the socket and receive electrical current. An electrical foot 32 disposed at the end of the threaded base 30 conductively connects the light bulb socket to the device. Electrical current in AC form flows into the metal foot 32 to power circuitry (not shown) that converts the electrical current to DC and thus powers the LEDs.

When backup lighting is required because of power failure, the battery powered LED grouping may be activated by means of a remote control. A sensor means 25 is adapted to receive signals from a user-operated remote control (not shown) and send signals to the control circuit. The control circuit activates the backup LED grouping by causing electrical current to be directed from the battery to the LEDs 22. The control circuit may further include a timing circuit, such as a 555 timing circuit or equivalent electronic timer, to control the duration of the battery powered LED operation after activation by the remote control means. The timing circuit may be programmable by the user or predetermined prior to purchasing the bulb. The remote control and sensor means 25 may communicate using radio frequency signals, which do not require a “line of sight” between the control and the sensor means 25. Alternatively, the remote control may communicate by infrared signals that require a user to operate the remote control within the “line of sight” of the sensor means 25 and have a substantial range of transmission coverage. Placement of the sensor means 25 is dependent on the embodiment of signal communications in use. It may be disposed at the top end of the lighting assembly 20 or along the base exposed portion of the lighting assembly base 21. For convenience of the user in times of power outage, the remote control may be constructed of a glow in the dark material. In a further embodiment of the present invention, the control circuit may automatically divert power to the battery powered LED lights when power is AC power is not present.

In use, an individual screws the light bulb into a light bulb socket such as those used with a traditional lamp. The lamp is turned on and the LEDs powered by the electrical current flowing through the metal threaded base 30 provide general lighting to the user. If a power outage occurs the individual may depress an “on/off” button on a remote control, thereby sending a signal to the sensor means 25. The sensor means 25 then signals the control circuitry to activate the battery powered LED grouping. The battery powered LEDs may be optionally controlled by a timing circuit after activation, limiting their operation per activation to a given time period. In this manner, the battery source 23 provides electricity to the LEDs so that a user may benefit from backup lighting.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim the following:

1) An emergency backup lighting device comprising:
an outer bulb shell;
said outer bulb shell comprising a top portion removably secured to a bottom portion;
said bottom portion having air vents disposed about its surface to release thermal energy;
a cylindrical inner lighting assembly housed within and removably connected at its base to said outer bulb shell;
said lighting assembly having a plurality of LEDs disposed along its outer surface;
a threaded base portion removably secured to said base of said lighting assembly;
adapted to draw electrical current from a standard incandescent bulb socket;
a control circuit including a rectifier for converting said electrical current into direct current for powering said LEDs,
a first set of said LEDs are electrically connected to said metal threaded base portion to receive said direct current derived from wall outlet power;
a second set of said LEDs being electrically connected to a battery source removably housed within said lighting assembly;
a wireless sensor adapted to receive signals from a remote control to activate said second set of LEDs.

2) A device as in claim 1, wherein said control circuit automatically illuminates said second set of LEDs when wall outlet power is not present.

3) A device as in claim 1, wherein said control circuit further comprises a timing circuit that provides power to said second set of LEDs for a given period of time after activation by said remote control.

4) An emergency backup lighting device comprising:
an outer bulb shell;
said outer bulb shell comprising a top portion removably secured to a bottom portion;
said bottom portion having air vents disposed about its surface to release thermal energy;
a cylindrical inner lighting assembly housed within and removably connected at its base to said outer bulb shell;
said lighting assembly having a plurality of LEDs disposed along its outer surface;
a threaded base portion removably secured to said base of said lighting assembly;
adapted to draw electrical current from a standard incandescent bulb socket;
control circuitry including a rectifier for converting said electrical current into direct current for powering said LEDs,
a first set of said LEDs are electrically connected to said metal threaded base portion to receive said direct current derived from wall outlet power;
a second set of said LEDs being electrically connected to a battery source removably housed within said lighting assembly;
said battery source is a rechargeable battery that receives continual charging from said direct current derived from wall outlet power;
a wireless sensor adapted to receive signals from a remote control to activate said second set of LEDs.

5) A device as in claim 4, wherein said first and second set of LEDs are simultaneously illuminated when wall outlet power is present.

6) A device as in claim 4, wherein said control circuit automatically illuminates said second set of LEDs when wall outlet power is not present.

7) A device as in claim 4, wherein said control circuit further comprises a timing circuit that provides power to said second set of LEDs for a given period of time after activation by said remote control.
